(19) United States
(12) Patent Application Publication
(10) Pub. No.: US 2026/0234398 A1
(43) Pub. Date: Aug. 13, 2026

(54) POLYAMIDE RESIN COMPOSITION

(71) Applicant: ASAHI KASEI KABUSHIKI KAISHA, Chiyoda-ku, Tokyo (JP)

(72) Inventors: Yuta HAYASHI, Chiyoda-ku, Tokyo (JP); Yuki ASANUMA, Chiyoda-ku, Tokyo (JP); Masashi WATANABE, Chiyoda-ku, Tokyo (JP); Miyabi HISHINUMA, Chiyoda-ku, Tokyo (JP)

(73) Assignee: ASAHI KASEI KABUSHIKI KAISHA, Chiyoda-ku, Tokyo (JP)

(21) Appl. No.: 19/150,189

(22) PCT Filed: Jan. 16, 2024
(86) PCT No.: PCT/JP2024/001018

§ 371 Date: Jul. 23, 2025

(30) Foreign Application Priority Data
Jan. 30, 2023 (JP) 2023-012274

(51) Int. Cl. C08L 77/06

(52) U.S. Cl. CPC C08L 77/06; C08L 2205/025; C08L 2205/03

(57) ABSTRACT

A polyamide resin composition is provided that achieves both compressive resistance characteristics and a high thermal expansion rate in addition to heat resistance, and is excellent in wear resistance and physical property retention rate upon water absorption. Since the polyamide resin composition of the present embodiment includes (A) a crystalline aliphatic polyamide resin and (B) a crystalline semi-aromatic polyamide at specific content ratios, a polyamide resin composition excellent in compressive resistance characteristics and toughness is achieved. Furthermore, since at least two crystalline polyamides crystallize at different temperatures, (C) a modified elastomer having a reactive functional group capable of reacting with an end group and/or main chain amide bond of a polyamide resin is well dispersed, resulting in a molded article having favorable thermal expansion rate, wear resistance, excellent surface appearance can be formed.

### TECHNICAL FIELD

The present disclosure relates to a polyamide resin composition.

### BACKGROUND

Polyamides, typified by polyamide 6 and polyamide 66 (hereinafter sometimes abbreviated as “PA6” and “PA66”, respectively), are excellent in moldability, mechanical properties, and chemical resistance. Therefore, polyamides are widely used as material components for various parts in applications such as automotive, electrical and electronic, industrial machinery, industrial materials, daily necessities, and household goods.

In recent years, with the demand for smaller and lighter products, the demand for polyamides, which are lighter than metals and have an excellent balance of rigidity and toughness, has increased.

In particular, in automobiles and industrial machinery, high heat resistance capable of withstanding temperature rise during operation is required. Furthermore, in peripheral components of drive parts such as gears, bearings, spacers, and rollers, high compressive load resistance during operation and high thermal expansion rate for filling gaps between parts, even at high temperatures, are required.

Here, a known problem with general aliphatic polyamides and their inorganic fiber-reinforced materials is that they have a low thermal expansion rate. In addition, although polyamides have relatively high heat resistance, due to temperature rise from frictional heat, mechanical properties deteriorate above a certain threshold temperature, resulting in a loss of functionality as components.

In order to solve the above-described problems, for example, PTL 1 discloses a composition comprising an alloy of partially aromatic polyamide resin and aliphatic polyamide. Further, PTL 2 discloses a composition comprising a crystalline aliphatic polyamide and a modified polyolefin resin.

### CITATION LIST

### Patent Literature

PTL 1: JP 7104548 B
PTL 2: WO 2022/009690 A1

### SUMMARY

### Technical Problem

As described above, the level of heat resistance, compressive resistance, and wear resistance for polyamide materials has been further increased, and in order to meet a high standard, further improvement of polyamide is required.

However, although the polyamide resin compositions disclosed in PTLs 1 and 2 can partially improve the problems of general aliphatic polyamides, improvement in compressive strength and wear resistance at high temperatures was insufficient. In particular, a polyamide resin composition achieving both high compressive strength and high thermal expansion rate has not yet been found.

The present disclosure has been made in view of the above circumstances and provides a polyamide resin composition which, when molded, exhibits excellent heat resistance, achieves both compressive resistance and high thermal expansion rate, and has excellent wear resistance and physical property retention rate upon water absorption.

### Solution to Problem

To solve the above problem, the present inventors have conducted intensive studies and discovered that the problem can be solved by containing a crystalline aliphatic polyamide, a crystalline semi-aromatic polyamide, a modified elastomer having a reactive functional group capable of reacting with end groups and/or main chain amide bonds of the polyamide resins, and a fibrous reinforcing filler in a polyamide resin composition, and by optimizing the content ratios of the crystalline semi-aromatic polyamide and the modified elastomer, thereby completing the present disclosure.

Thus, the present disclosure is as follows:

(1):

A polyamide resin composition comprising:
(A) at least one crystalline aliphatic polyamide;
(B) at least one crystalline semi-aromatic polyamide obtained through a condensation of a diamine having a linear hydrocarbon chain (including a backbone having a side chain) and a dicarboxylic acid having at least one aromatic ring in the molecule thereof;
(C) at least one modified elastomer having a reactive functional group capable of reacting with an end group and/or main chain amide bond of a polyamide resin and having a glass transition temperature of 23° C. or lower; and
(D) a fibrous reinforcing filler,
wherein a mass ratio of a content of the (B) crystalline semi-aromatic polyamide to a total content of the (A) crystalline polyamide and the (B) crystalline semi-aromatic polyamide is 0.10 or more and 0.50 or less.
   (2):

The polyamide resin composition according to (1), wherein a content of the (A) crystalline aliphatic polyamide is 50 mass % or more and 90 mass % or less relative to a total mass of the polyamide resin composition.

(3):

The polyamide resin composition according to (1) or (2), wherein a ratio (C/N) of a number C of carbon atoms to a number N of nitrogen atoms in a repeating unit of the (A) crystalline aliphatic polyamide is 5.0 or more and 8.0 or less.

(4):

The polyamide resin composition according to any one of (1) to (3), wherein the content of the (B) crystalline semi-aromatic polyamide is 5 mass % or more and 50 mass % or less relative to the total mass of the polyamide resin composition.

(5):

The polyamide resin composition according to any one of (1) to (4), wherein a ratio (C/N) of a number C of carbon atoms to a number N of nitrogen atoms in a repeating unit of the (B) crystalline semi-aromatic polyamide is 5.0 or more and 8.0 or less.

(6):

The polyamide resin composition according to any one of (1) to (5), wherein terephthalic acid accounts for 80 mol % or more of dicarboxylic acids constituting the (B) crystalline semi-aromatic polyamide.

(7):

The polyamide resin composition according to any one of (1) to (6), wherein the (B) crystalline semi-aromatic polyamide is polyamide 4T or a copolyamide containing polyamide 4T.

(8):

The polyamide resin composition according to any one of (1) to (7), wherein a total content of the (A) crystalline aliphatic polyamide and the (B) crystalline semi-aromatic polyamide is 80 mass % or more relative to all polyamides in the polyamide resin composition.

(9):

The polyamide resin composition according to any one of (1) to (8), wherein the polyamide resin composition has two or more melting points, and a difference between the lowest melting point peak temperature (Tm-1) and the highest melting point peak temperature (Tm-2) is 40° C. or higher and 100° C. or lower.

(10):

The polyamide resin composition according to any one of (1) to (9), wherein a mass ratio of a content of the (C) modified elastomer to the total content of the (A) crystalline polyamide and the (B) crystalline semi-aromatic polyamide is 0.10 or more and 0.50 or less.

(11):

The polyamide resin composition according to any one of (1) to (10), wherein the content of the (C) modified elastomer is 0.1 mass % or more and 15 mass % or less relative to the total mass of the polyamide resin composition.

(12):

The polyamide resin composition according to any one of (1) to (11), wherein the (C) modified elastomer is a modified polyolefin-based resin having a reactive functional group capable of reacting with an end group and/or main chain amide bond of a polyamide resin and having a glass transition temperature of 23° C. or lower.

(13):

The polyamide resin composition according to any one of (1) to (12), wherein a content of the (D) fibrous reinforcing filler is 10 mass % or more and 50 mass % or less relative to the total mass of the polyamide resin composition.

(14):

The polyamide resin composition according to any one of (1) to (13), wherein a linear expansion coefficient in a range of −40° C. to 150° C. is 15×10⁻⁵/K or more.

### Advantageous Effect

According to the present disclosure, it is possible to provide a polyamide resin composition which, when molded, exhibits excellent heat resistance, achieves both compressive resistance and high thermal expansion rate, and has excellent wear resistance and physical property retention rate upon water absorption.

### DETAILED DESCRIPTION

Hereinafter, an embodiment for embodying the present disclosure (hereinafter referred to merely as “the present embodiment”) will be described in detail.

Note that the present embodiment set forth below is an illustrative embodiment for describing the present disclosure and is not intended to limit the present disclosure to the following matter. The present disclosure can be implemented with appropriate modifications that do not deviate from the gist thereof.

In this specification, the “term polyamide” refers to a polymer having amide groups (—NHCO—) in the main chain.

### [Polyamide Resin Composition]

The polyamide resin composition of the present embodiment contains the following (A) to (D):
(A) at least one crystalline aliphatic polyamide;
(B) at least one crystalline semi-aromatic polyamide obtained through a condensation of a diamine having an aliphatic hydrocarbon chain (including a skeleton having a side chain) and a dicarboxylic acid having at least one aromatic ring in the molecule (hereinafter also simply referred to as “(B) crystalline semi-aromatic polyamide”);
(C) at least one modified elastomer having a reactive functional group capable of reacting with an end group and/or main chain amide bond of a polyamide resin and having a glass transition temperature of 23° C. or lower (hereinafter also simply referred to as “(C) modified elastomer”); and
(D) a fibrous reinforcing filler,
wherein, in the polyamide resin composition of the present embodiment, the content ratio of the (B) crystalline semi-aromatic polyamide to the total content of the (A) crystalline polyamide and the (B) crystalline semi-aromatic polyamide is 0.10 or more and 0.50 or less.

The polyamide resin composition of the present embodiment contains the (A) crystalline aliphatic polyamide resin and the (B) crystalline semi-aromatic polyamide in a specific range of content ratio, thereby providing a polyamide resin composition excellent in compressive resistance and toughness. In addition, since at least two crystalline polyamides crystallize at different temperatures, the (C) modified elastomer is well dispersed in the amorphous regions of the respective polyamide resins, thereby achieving uniform and excellent thermal expansion rate and wear resistance, and enabling the production of molded articles having excellent surface appearance.

The following describes each component constituting the polyamide resin composition of the present embodiment in detail.

### <Polyamide>

### ((A) Crystalline Aliphatic Polyamide)

The polyamide resin composition of the present embodiment contains (A) an aliphatic polyamide.

Here, it is preferable that the (A) aliphatic polyamide contains the following structural units (1) or (2):
(1) (A-a) an aliphatic dicarboxylic acid unit and (A-b) an aliphatic diamine unit;
(2) at least one selected from the group consisting of (A-c) a lactam unit and an aminocarboxylic acid unit.

The (A) crystalline aliphatic polyamide has a melting peak temperature Tm2 of higher than 180° C., preferably 200° C. or higher, more preferably 230° C. or higher, and still more preferably 250° C. or higher, as measured by differential scanning calorimetry in accordance with JIS K 7121.

On the other hand, the melting peak temperature Tm2 is preferably 320° C. or lower, more preferably 310° C. or lower, and still more preferably 300° C. or lower.

That is, the melting peak temperature Tm2 is preferably higher than 180° C. and 320° C. or lower, more preferably 230° C. or higher and 310° C. or lower, and still more preferably 250° C. or higher and 300° C. or lower. The method for measuring the melting peak temperature Tm2 will be described in detail later.

Examples of the aliphatic dicarboxylic acid constituting the (A-a) aliphatic dicarboxylic acid unit include straight-chain or branched saturated aliphatic dicarboxylic acids having 3 or more and 20 or fewer carbon atoms, and straight-chain or branched unsaturated aliphatic dicarboxylic acids having 4 or more and 20 or fewer carbon atoms.

Specific examples of straight-chain saturated aliphatic dicarboxylic acids having 3 or more and 20 or fewer carbon atoms include the following, but are not limited to, malonic acid, succinic acid, glutaric acid, adipic acid, pimelic acid, suberic acid, azelaic acid, sebacic acid, dodecanedioic acid, tetradecanedioic acid, hexadecanedioic acid, octadecanedioic acid, eicosanedioic acid, and diglycolic acid.

Specific examples of branched-chain saturated aliphatic dicarboxylic acids having 3 or more and 20 or fewer carbon atoms include the following, but are not limited to, dimethylmalonic acid, 2,2-dimethylsuccinic acid, 2,3-dimethylglutaric acid, 2,2-diethylsuccinic acid, 2,3-diethylglutaric acid, 2,2-dimethylglutaric acid, 2-methyladipic acid, and trimethyladipic acid.

One of these aliphatic dicarboxylic acids constituting the (A-a) aliphatic dicarboxylic acid unit may be used alone, or two or more aliphatic dicarboxylic acids may be used in combination.

Among these, from the viewpoint of further enhancing compressive resistance, thermal expansion rate, wear resistance, toughness, physical property retention rate upon water absorption, and the like of the polyamide composition, it is preferable that the aliphatic dicarboxylic acid constituting the (A-a) aliphatic dicarboxylic acid unit is an aliphatic dicarboxylic acid having 4 or more and 12 or fewer carbon atoms, more preferably a straight-chain aliphatic dicarboxylic acid having 4 or more and 12 or fewer carbon atoms, and still more preferably a straight-chain saturated aliphatic dicarboxylic acid having 4 or more and 12 or fewer carbon atoms.

Examples of still more preferable straight-chain saturated aliphatic dicarboxylic acids having 4 or more and 12 or fewer carbon atoms include succinic acid, glutaric acid, adipic acid, pimelic acid, suberic acid, azelaic acid, sebacic acid, 1,9-nonanedicarboxylic acid, and 1,10-decanedicarboxylic acid.

Among these, from the viewpoint of heat resistance of the polyamide composition, it is particularly preferable that the straight-chain saturated aliphatic dicarboxylic acid having 4 or more and 10 or fewer carbon atoms is succinic acid, adipic acid, or sebacic acid.

Examples of aliphatic diamines constituting the (A-b) aliphatic diamine unit include straight-chain saturated aliphatic diamines having 2 or more and 20 or fewer carbon atoms, branched saturated aliphatic diamines having 3 or more and 20 or fewer carbon atoms, straight-chain unsaturated aliphatic diamines having 2 or more and 20 or fewer carbon atoms, and branched unsaturated aliphatic diamines having 3 or more and 20 or fewer carbon atoms.

Examples of straight-chain saturated aliphatic diamines having 2 or more and 20 or fewer carbon atoms include the following, but are not limited to, ethylenediamine, propylenediamine, tetramethylenediamine, pentamethylenediamine, hexamethylenediamine, heptamethylenediamine, octamethylenediamine, nonamethylenediamine, decamethylenediamine, undecamethylenediamine, dodecamethylenediamine, and tridecamethylenediamine.

Examples of branched saturated aliphatic diamines having 3 or more and 20 or fewer carbon atoms include, but are not limited to, 2-methylpentamethylenediamine (also referred to as 2-methyl-1,5-diaminopentane), 2,2,4-trimethylhexamethylenediamine, 2,4,4-trimethylhexamethylenediamine, 2-methyl-1,8-octanediamine (also referred to as 2-methyloctamethylenediamine), and 2,4-dimethyloctamethylenediamine.

One of these aliphatic diamines constituting the aliphatic diamine unit (A-b) may be used alone, or two or more of these may be used in combination.

Among these, it is preferable that the aliphatic diamine constituting the (A-b) aliphatic diamine unit is a straight-chain aliphatic diamine. Further, the number of carbon atoms of the aliphatic diamine constituting the (A-b) aliphatic diamine unit is preferably 4 or more and 12 or less, and more preferably 6 or more and 10 or less. When the number of carbon atoms of the aliphatic diamine constituting the (A-b) aliphatic diamine unit is equal to or greater than the above lower limit, the resulting molded article has better heat resistance. On the other hand, when the number of carbon atoms is equal to or less than the above upper limit, the resulting molded article has better crystallinity and mold release properties. Furthermore, it is more preferable that the aliphatic diamine constituting the (A-b) aliphatic diamine unit is an aliphatic diamine having 4 or more and 10 or fewer carbon atoms.

Examples of more preferable straight-chain or branched saturated aliphatic diamines having 4 or more and 10 or fewer carbon atoms include tetramethylenediamine, pentamethylenediamine, hexamethylenediamine, 2-methylpentamethylenediamine, 2-methyl-1,8-octanediamine, heptamethylenediamine, octamethylenediamine, nonamethylenediamine, and decamethylenediamine.

Among them, preferred examples of straight-chain saturated aliphatic diamines having 4 or more and 10 or fewer carbon atoms are tetramethylenediamine, hexamethylenediamine, or 2-methylpentamethylenediamine. By including such (A-b) aliphatic diamine units, the molded article obtained from the polyamide composition has better heat resistance and compressive resistance characteristics.

The (A) crystalline aliphatic polyamide may also contain at least one selected from the group consisting of (A-c) a lactam unit and an aminocarboxylic acid unit, instead of the (A-a) aliphatic dicarboxylic acid unit and (A-b) aliphatic diamine unit. The inclusion of such units tends to provide polyamides with excellent toughness.

As used herein, the term “lactam unit” and “aminocarboxylic acid unit” refer to the polymerized (condensed) forms of lactams and aminocarboxylic acids, respectively.

Examples of the lactams constituting the lactam units include the following, but are not limited to, for example, butyrolactam, pivalolactam, ε-caprolactam, caprylolactam, enantholactam, undecanolactam, and laurolactam (dodecanolactam).

Examples of the aminocarboxylic acid constituting aminocarboxylic acid units include the following, but are not limited to, for example, ω-aminocarboxylic acids and α,ω-amino acids, which are formed by the ring opening of lactams.

The lactams and aminocarboxylic acids constituting at least one selected from the group consisting of (A-c) the lactam units and the aminocarboxylic acid unit may be used individually or in combination of two or more.

Furthermore, from the viewpoint of heat resistance, compressive resistance characteristics, thermal expansion rate, wear resistance, toughness, physical property retention rate upon water absorption, and the surface appearance of molded articles, the (A) aliphatic polyamide contained in the polyamide composition of the present embodiment is preferably a polyamide containing structural units derived from a dicarboxylic acid and a diamine, more preferably a polyamide containing aliphatic dicarboxylic acid units and aliphatic diamine units, more preferably a polyamide containing aliphatic dicarboxylic acid units having 4 or more and 10 or fewer carbon atoms and aliphatic diamine units having 4 or more and 10 or fewer carbon atoms, still more preferably a polyamide containing saturated aliphatic dicarboxylic acid units having 4 or more and 10 or fewer carbon atoms and saturated aliphatic diamine units having 4 or more and 10 or fewer carbon atoms, particularly preferably polyamide 46 (PA46), polyamide 66 (PA66), or polyamide 610 (PA610), and most preferably PA66. PA66 is considered to be a material suitable for automotive parts and industrial machinery applications because of its excellent mechanical properties, heat resistance, moldability, and toughness.

In addition, the content of the (A) crystalline aliphatic polyamide in the polyamide resin composition of the present embodiment may be, for example, 50 mass % or more and 90 mass % or less, more preferably 50 mass % or more and 80 mass % or less, and still more preferably 50 mass % or more and 70 mass % or less, relative to the total mass of the polyamides in the polyamide resin composition.

### ((B) Crystalline Semi-Aromatic Polyamide)

The polyamide resin composition of the present embodiment contains (B) a crystalline semi-aromatic polyamide, in addition to the (A) aliphatic polyamide.

Here, the (B) crystalline semi-aromatic polyamide is a polyamide containing (B-a) a dicarboxylic acid unit and (B-b) a diamine acid unit.

It is preferable that the (B) crystalline semi-aromatic polyamide contains 30 mol % or more of aromatic structural units, more preferably 40 mol % or more of aromatic structural units, still more preferably 50 mol % or more of aromatic structural units, and most preferably 60 mol % or more of aromatic structural units, relative to all structural units of the (B) crystalline semi-aromatic polyamide.

The term “aromatic constituting unit” as used herein refers to aromatic diamine units and aromatic dicarboxylic acid units.

The (B) crystalline semi-aromatic polyamide preferably has a melting peak temperature Tm2 of higher than 280° C., preferably 300° C. or higher, still more preferably 310° C. or higher, further more preferably 320° C. or higher, and most preferably 330° C. or higher, as measured by differential scanning calorimetry in accordance with JIS K 7121. The method for measuring the melting peak temperature Tm2 will be described in detail later.

The (B-a) dicarboxylic acid unit includes a dicarboxylic acid unit having 4 or more and 12 or fewer carbon atoms, and preferably includes a terephthalic acid unit. A polyamide including a terephthalic acid unit as the (B-a) dicarboxylic acid unit has higher crystallinity and lower water absorption rate, and therefore provides a polyamide resin composition which gives molded articles having better heat resistance and compressive strength, as well as excellent physical property retention rate upon water absorption and low dimensional change rate.

The (B-a) dicarboxylic acid unit preferably contains terephthalic acid in an amount of 50 mol % or more, more preferably 65 mol % or more, still more preferably 70 mol % or more, particularly preferably 90 mol % or more, and most preferably 100 mol %, relative to the total moles of (B-a) dicarboxylic acids constituting the (B) crystalline semi-aromatic polyamide.

When the proportion of the terephthalic acid unit in the (B-a) dicarboxylic acid unit is equal to or greater than the above lower limit, a polyamide resin composition tends to be obtained which simultaneously satisfies heat resistance, compressive resistance characteristics, wear resistance, physical property retention rate upon water absorption, thermal expansion rate, and the like. In addition, the molded article obtained from the polyamide resin composition tends to have better surface appearance.

Further, the (B-a) dicarboxylic acid unit may contain at least one dicarboxylic acid unit other than the terephthalic acid unit, within a range not impairing the effects thereof. Examples of the other dicarboxylic acid units include, but are not particularly limited to, for example, dicarboxylic acids having a benzene ring skeleton or a naphthalene skeleton.

The aromatic ring moiety of the aromatic dicarboxylic acid unit other than terephthalic acid may be unsubstituted or may have a substituent. Examples of the substituent include, but are not particularly limited to, for example, alkyl groups having a carbon number of 1 or more and 4 or less, aryl groups having a carbon number of 6 or more and 10 or less, aralkyl groups having having a carbon number of 7 or more and 10 or less, halogen groups such as chloro and bromo groups, silyl groups having a carbon number of 1 or more and 6 or less, and sulfonic acid groups and salts (such as sodium salt) thereof.

Specifically, examples of the dicarboxylic acid other than the terephthalic acid include the following, but are not limited to aromatic dicarboxylic acids having a carbon number of 8 or more and 20 or less that are unsubstituted or substituted with a certain substituent, such as isophthalic acid, naphthalenedicarboxylic acid, 2-chloroterephthalic acid, 2-methylterephthalic acid, 5-methylisophthalic acid, and 5-sodium sulfoisophthalic acid, for example.

As the (B-b) diamine unit constituting the (B) crystalline semi-aromatic polyamide, it is preferable to include at least one aliphatic diamine unit having a linear hydrocarbon chain (including a skeleton having a side chain). The (b-1) aliphatic diamine unit includes preferably a diamine unit having 4 or more and 12 or fewer carbon atoms, more preferably 4 or more and 10 or fewer carbon atoms, and particularly preferably 4 or more and 6 or fewer carbon atoms. When the number of carbon atoms in the aliphatic diamine is within the above range, the heat resistance, compressive resistance characteristics, and the like of the polyamide resin composition become more excellent.

The content ratio of the (b-1) aliphatic diamine unit is preferably 50 mol % or more, more preferably 60 mol % or more, still more preferably 90 mol % or more, and particularly preferably 100 mol %, relative to the total molar amount of the diamine units constituting the (B) crystalline semi-aromatic polyamide. By setting the content ratio of the (b-1) aliphatic diamine unit within the above range, a polyamide tends to be obtained which has a higher glass transition temperature Tg, higher crystallinity (i.e., higher ΔHc), and further improved heat resistance, compressive resistance characteristics, toughness, and physical property retention rate upon water absorption.

Examples of aliphatic diamines constituting the (b-1) aliphatic diamine unit include linear aliphatic diamines and branched aliphatic diamines.

Examples of linear aliphatic diamines include, but are not limited to, tetramethylenediamine, pentamethylenediamine, hexamethylenediamine, heptamethylenediamine, octamethylenediamine, nonamethylenediamine, decamethylenediamine, undecamethylenediamine, and dodecamethylenediamine.

Examples of branched aliphatic diamines include, but are not limited to, 2-methylpentamethylenediamine (also referred to as 2-methyl-1,5-diaminopentane), 2,2,4-trimethylhexamethylenediamine, 2,4,4-trimethylhexamethylenediamine, 2-methyl-1,8-octanediamine (also referred to as 2-methyloctamethylenediamine), and 2,4-dimethyloctamethylenediamine.

The (B-b) diamine unit may contain at least one (b-2) diamine unit other than the (b-1) aliphatic diamine unit, within a range not impairing the effect thereof.

Further, the content of the (B) crystalline semi-aromatic polyamide in the polyamide resin composition of the present embodiment may be, for example, 5 mass % or more and 50 mass % or less, more preferably 10 mass % or more and 40 mass % or less, and still more preferably 15 mass % or more and 30 mass % or less, relative to the total mass of the polyamides in the polyamide resin composition.

The mass ratio [(B)/((A)+(B))] of the (B) crystalline semi-aromatic polyamide to the total mass of the (A) crystalline aliphatic polyamide and the (B) crystalline semi-aromatic polyamide contained in the polyamide resin composition of the present embodiment is preferably 0.10 or more and 0.50 or less, more preferably 0.10 or more and 0.40 or less, and still more preferably 0.15 or more and 0.35 or less.

By setting the mass ratio of the (B) crystalline semi-aromatic polyamide to the total content of the (A) crystalline aliphatic polyamide and the (B) crystalline semi-aromatic polyamide within the above range, the molded article obtained from the polyamide resin composition tends to have excellent heat resistance and compressive resistance characteristics, and excellent surface appearance.

The sum of the mass of the (A) crystalline aliphatic polyamide and the mass of the (B) crystalline semi-aromatic polyamide is preferably 80 mass % or more, more preferably 85 mass % or more, still more preferably 90 mass % or more, particularly preferably 95 mass % or more, and most preferably 100 mass %, relative to the total mass of the polyamide resins in the polyamide resin composition of the present embodiment.

### (Capping of Ends of Polyamides)

Further, the ends of the polyamides (the (A) crystalline aliphatic polyamide and the (B) crystalline semi-aromatic polyamide) contained in the polyamide resin composition of the present embodiment may be capped with a known end-capping agent.

Such an end-capping agent can be added as a molecular weight regulator when a polyamide is manufactured from the dicarboxylic acids and diamines described above, or from at least one selected from the group consisting of the lactams and aminocarboxylic acids described above.

Examples of the end-capping agent are not limited to the following but include monocarboxylic acids, monoamines, acid anhydrides (such as phthalic anhydride), monoisocyanates, monoacid halides, monoesters, and mono alcohols, for example. One end-capping agent may be used alone or two or more end-capping agents may be used in a combination.

Among these, monocarboxylic acids or monoamines are preferable as the end-capping agent. By capping the ends of the polyamides with the end-capping agent, the molded article obtained from the polyamide composition tends to exhibit more excellent thermal stability.

The monocarboxylic acids that can be used as the end-capping agent are not particularly limited as long as they have reactivity with the amino groups that may be present at the ends of the polyamide. Examples of monocarboxylic acids include the following but are not limited to, for example, aliphatic monocarboxylic acids, alicyclic monocarboxylic acids, and aromatic monocarboxylic acids.

Examples of aliphatic monocarboxylic acids include formic acid, acetic acid, propionic acid, butyric acid, valeric acid, caproic acid, caprylic acid, lauric acid, tridecanoic acid, myristic acid, palmitic acid, stearic acid, pivalic acid, and isobutyric acid.

Examples of alicyclic monocarboxylic acids include cyclohexanecarboxylic acid.

Examples of aromatic monocarboxylic acids include benzoic acid, toluic acid, a-naphthoic acid, P-naphthoic acid, methylnaphthoic acid, and phenylacetic acid.

One of these monocarboxylic acids may be used alone, or two or more of these may be used in combination.

In particular, the end of the (B) semi-aromatic polyamide is preferably capped with acetic acid from the viewpoint of flowability and mechanical strength.

The monoamines that can be used as end-capping agent are not particularly limited as long as they have reactivity with the carboxyl groups that may be present at the ends of the polyamide. Examples of the monoamines include the following but are not limited to, for example, aliphatic monoamines, alicyclic monoamines, and aromatic monoamines.

Examples of the aliphatic monoamines include methylamine, ethylamine, propylamine, butylamine, hexylamine, octylamine, decylamine, stearylamine, dimethylamine, diethylamine, dipropylamine, and dibutylamine.

Examples of alicyclic monoamines include cyclohexylamine and dicyclohexylamine.

Examples of aromatic monoamines include aniline, toluidine, diphenylamine, and naphthylamine.

One of these monoamines may be used alone, or two or more of these may be used in combination.

The polyamide resin composition containing a polyamide of which end is capped with an end-capping agent tends to exhibit better heat resistance, compressive resistance characteristics, toughness, low water absorption, and surface appearance of the molded article.

### (Method for Producing Polyamides)

The method for producing the polyamides (the (A) crystalline aliphatic polyamide and the (B) crystalline semi-aromatic polyamide) contained in the polyamide resin composition of the present embodiment will now be described.

When producing the polyamides, it is preferable that the addition amounts of the dicarboxylic acid and the diamine are approximately equimolar. Taking into account the escape of diamines from the reaction system during polymerization, the molar amount of the total diamines in terms of molar ratio is preferably 0.9 or more and 1.2 or less, more preferably 0.95 or more and 1.1 or less, and even more preferably 0.98 or more and 1.05 or less, per 1 mol of the total dicarboxylic acids.

The method of producing the polyamide is not limited to the following, but may include, for example, the polymerization step of (1) or (2) below.
(1) The step of polymerizing a combination of the dicarboxylic acid constituting the dicarboxylic acid unit and the diamine constituting the diamine unit to obtain a polymer.
(2) The step of polymerizing one or more selected from the group consisting of a lactam constituting the lactam unit and an aminocarboxylic acid constituting the aminocarboxylic acid unit to obtain a polymer.

It is also preferred that the method of producing the polyamide further includes, after the polymerization step, a raising step to raise the degree of polymerization of the polyamide. If necessary, the polymerization step and the rising step may be followed by a capping step in which the ends of the resulting polymer are capped with an end-capping agent.

Specific methods of producing the polyamide include various methods as exemplified in 1) to 4) below.
1) A method in which an aqueous solution or aqueous suspension of one or more selected from the group consisting of a dicarboxylic acid-diamine salt, a mixture of a dicarboxylic acid and a diamine, a lactam, and an aminocarboxylic acid is heated and polymerized while the molten state is maintained (hereinafter sometimes referred to as “thermal melt polymerization method”).
2) A method in which a polyamide obtained through the thermal melt polymerization method is maintained in the solid state at a temperature equal to or lower than the melting point to increase the degree of polymerization of the polyamide (hereinafter sometimes referred to as “thermal melt polymerization-solid phase polymerization method”).
3) A method in which one or more selected from the group consisting of a dicarboxylic acid-diamine salt, a mixture of a dicarboxylic acid and a diamine, a lactam, and an aminocarboxylic acid is polymerized while maintaining a solid state (hereinafter referred to as “solid phase polymerization method”).
4) A method in which a dicarboxylic acid halide component equivalent to a dicarboxylic acid and a diamine component are used for polymerization (hereinafter sometimes referred to as the “solution method”).

Of these, production methods involving the 1) thermal melt polymerization method are preferred as the specific method of producing the polyamide. In addition, when a polyamide is produced by the thermal melt polymerization method, it is preferable to maintain the molten state until polymerization is completed. In order to maintain the molten state, it is necessary to produce the polyamide composition under polymerization conditions suitable for the polyamide composition. The polymerization conditions include, for example, the following conditions. First, the polymerization pressure in the thermal melt polymerization method is controlled to 14 kg/cm² or more and 25 kg/cm² or less (gauge pressure), and heating is continued. The pressure in the tank is then lowered over 30 minutes or longer until it reaches atmospheric pressure (the gauge pressure indicates 0 kg/cm²).

In the method of producing the polyamide, the mode of polymerization is not limited and can be batch or continuous.

The polymerization apparatus used for the production of the polyamide is not particularly limited, and any known apparatus can be used. Specific examples of the polymerization apparatus include autoclave-type reactors, tumbler-type reactors, and extruder-type reactors (kneaders, etc.), for example.

A method of producing the polyamide by the batch thermal melt polymerization method will be specifically described, but the method of producing a polyamide is not limited to this method. The temperature and the pressure can be appropriately adjusted depending on the type of the polyamide to be produced.

First, an aqueous solution containing approximately 40 mass % or more and 60 mass % or less of the raw material components for the polyamide (at least one selected from the group consisting of a combination of dicarboxylic acid and diamine, and optionally lactams and aminocarboxylic acids) is prepared. The aqueous solution is then concentrated in a concentration tank operated at a temperature of 110° C. or higher and 180° C. or lower and a pressure of about 0.035 MPa or more and 0.6 MPa or less (gauge pressure) to obtain a concentrated solution of about 65 mass % or more and 90 mass % or less.

The resulting concentrated solution is then transferred to an autoclave, and heating is continued until the pressure in the autoclave reaches about 1.2 MPa or more and 2.2 MPa or less (gauge pressure).

Then, in the autoclave, the pressure is maintained at about 1.2 MPa or more and 2.2 MPa or less (gauge pressure) while at least one of water and the gas component are vented. Then, when the temperature reaches about 220° C. or higher and 260° C. or lower, the pressure is lowered to atmospheric pressure (gauge pressure is 0 MPa). After the pressure in the autoclave is reduced to atmospheric pressure, by-produced water can be effectively removed by depressurizing as necessary.

The autoclave is then pressurized with inert gas such as nitrogen, and the polyamide melt is extruded from the autoclave into strands. The extruded strands are cooled and cut to obtain pellets of a polyamide.

### (Polymer Ends of Polyamides)

The polymer ends of the polyamides (the (A) aliphatic polyamide and the (B) semi-aromatic polyamide) contained in the polyamide composition of the present embodiment are not particularly limited but can be classified and defined into the following categories 1) to 4).

Specifically, they include 1) an amino end, 2) a carboxyl end, 3) an end by an end-capping agent, and 4) other ends.
1) An amino end is a polymer end having an amino group (—NH₂ group) and is derived from a diamine unit.
2) A carboxyl end is a polymer end having a carboxyl group (—COOH group) and is derived from a dicarboxylic acid.
3) An end by an end-capping agent is an end formed when an end-capping agent is added during polymerization. End-capping agents include the end-capping agents described above.
4) Other ends are polymer ends that are not classified into the above-described 1) to 3). Specific examples of other ends include ends generated by a deamination reaction of amino ends and ends generated by a decarboxylation reaction of carboxyl ends.

### (Properties of (A) Aliphatic Polyamide and (B) Crystalline Semi-Aromatic Polyamide)

The melting point Tm2(A), the crystallization enthalpy ΔH(A), and the tan δ peak temperature tan δ(A) of the (A) aliphatic polyamide, and the melting point Tm(B), the crystallization enthalpy ΔH(B), and the tan δ peak temperature tan δ(B) of the (B) crystalline semi-aromatic polyamide are preferably as described below, and can specifically be measured by the methods described below.

The melting point Tm2(A) of the (A) crystalline aliphatic polyamide is preferably 220° C. or higher, more preferably 230° C. or higher, and even more preferably 240° C. or higher. On the other hand, the melting point Tm2(A) of the (A) crystalline aliphatic polyamide is preferably 300° C. or lower, more preferably 290° C. or lower, even more preferably 280° C. or lower, and particularly preferably 270° C. or lower.

That is, the melting point Tm2(A) of the (A) crystalline aliphatic polyamide is preferably 220° C. or higher and 300° C. or lower, more preferably 230° C. or higher and 290° C. or lower, even more preferably 240° C. or higher and 280° C. or lower, and particularly preferably 240° C. or higher and 270° C. or lower.

When the melting point Tm2(A) of the (A) crystalline aliphatic polyamide is equal to or greater than the above lower limit, the molded article obtained from the polyamide composition tends to have improved heat resistance and compressive resistance characteristics. On the other hand, when the melting point Tm2(A) of the (A) crystalline aliphatic polyamide is equal to or less than the above upper limit, thermal decomposition of the polyamide composition during melt processing such as extrusion or molding can be more suppressed, and the appearance of the molded article tends to be better.

Further, from the viewpoint of mechanical properties, particularly rigidity upon water absorption and rigidity upon heating, the crystallization enthalpy ΔH of the (A) crystalline aliphatic polyamide is preferably 30 J/g or more, more preferably 40 J/g or more, even more preferably 50 J/g or more, and particularly preferably 60 J/g or more. On the other hand, the crystallization enthalpy ΔH of the (A) crystalline aliphatic polyamide is not particularly limited and may preferably be as high as possible.

Examples of measurement devices for the melting point Tm2-1 and crystallization enthalpy ΔH of the (A) crystalline aliphatic polyamide include Diamond-DSC manufactured by PERKIN-ELMER.

The crystallization enthalpy ΔHc of the polyamide is the peak area of Tc when the polyamide is cooled at a cooling rate of 20° C./min and an exothermic peak (crystallization peak) appears, and the temperature of the crystallization peak is defined as the crystallization peak temperature Tc (° C.).

Furthermore, the tan δ peak temperature of the (A) crystalline aliphatic polyamide is preferably 40° C. or higher, more preferably 50° C. or higher and 110° C. or lower, even more preferably 60° C. or higher and 100° C. or lower, particularly preferably 70° C. or higher and 95° C. or lower, and most preferably 80° C. or higher and 90° C. or lower.

When the tan δ peak temperature of the (A) crystalline aliphatic polyamide is equal to or higher than the above lower limit, the performance such as heat resistance and compressive resistance characteristics of the molded article obtained from the polyamide composition tends to be more excellent.

The tan δ peak temperature of the (A) crystalline aliphatic polyamide can be measured using a dynamic mechanical analyzer (for example, DVE-V4 manufactured by Rheology) or the like.

Furthermore, the ratio (C/N) of the number of carbon atoms C to the number of nitrogen atoms N in the (A) crystalline aliphatic polyamide contained in the polyamide resin composition of the present embodiment is preferably 3.0 or more and 9.0 or less, more preferably 4.0 or more and 8.0 or less, even more preferably 4.5 or more and 7.0 or less, particularly preferably 5.0 or more and 6.5 or less, and most preferably 5.0 or more and 6.0 or less.

By setting the ratio (C/N) of the number of carbon atoms C to the number of nitrogen atoms N in the (A) crystalline aliphatic polyamide within the above range, a polyamide composition having excellent heat resistance and compressive strength can be obtained. Moreover, the molded article obtained from the polyamide composition tends to have a better surface appearance.

The melting point Tm(B) of the (B) crystalline semi-aromatic polyamide is preferably 280° C. or higher, more preferably 290° C. or higher, and particularly preferably 300° C. or higher. On the other hand, the melting point Tm(B) of the (B) crystalline semi-aromatic polyamide is preferably 360° C. or lower, more preferably 350° C. or lower, and particularly preferably 340° C. or lower.

That is, the melting point Tm(B) of the (B) crystalline semi-aromatic polyamide is preferably 280° C. or higher and 360° C. or lower, more preferably 290° C. or higher and 350° C. or lower, and particularly preferably 300° C. or higher and 340° C. or lower.

When the melting point Tm(B) of the (B) crystalline semi-aromatic polyamide is equal to or greater than the above lower limit, the molded article obtained from the polyamide composition tends to have improved heat resistance and compressive resistance characteristics. On the other hand, when the melting point Tm(B) of the (B) crystalline semi-aromatic polyamide is equal to or less than the above upper limit, thermal decomposition during melt processing such as extrusion or molding can be more suppressed, and the appearance of the molded article tends to be better.

Further, from the viewpoint of mechanical properties, particularly rigidity upon water absorption and rigidity upon heating, the crystallization enthalpy ΔH(B) of the (B) crystalline semi-aromatic polyamide is preferably 30 J/g or more and 70 J/g or less, more preferably 35 J/g or more and 65 J/g or less, and particularly preferably 40 J/g or more and 60 J/g or less. On the other hand, the crystallization enthalpy ΔH(B) of the (B) crystalline semi-aromatic polyamide is not particularly limited, and may preferably be as high as possible.

Examples of measurement devices for the melting point Tm(B) and crystallization enthalpy ΔH(B) of the (B) crystalline semi-aromatic polyamide include Diamond-DSC manufactured by PERKIN-ELMER.

Furthermore, the tan δ peak temperature tan δ(B) of the (B) crystalline semi-aromatic polyamide is preferably 80° C. or higher, more preferably 90° C. or higher and 160° C. or lower, even more preferably 100° C. or higher and 155° C. or lower, particularly preferably 110° C. or higher and 150° C. or lower, and most preferably 120° C. or higher and 150° C. or lower.

When the tan δ peak temperature tan δ(B) of the (B) crystalline semi-aromatic polyamide is equal to or greater than the above lower limit, the molded article obtained from the polyamide composition tends to exhibit better heat resistance and physical property retention rate upon water absorption.

The tan δ peak temperature tan δ(B) of the (B) crystalline semi-aromatic polyamide can be measured using a viscoelasticity measurement analyzer (e.g., DVE-V4 manufactured by Rheology) or the like.

Furthermore, the ratio (C/N) of the number of carbon atoms C to the number of nitrogen atoms N in the (B) crystalline semi-aromatic polyamide contained in the polyamide resin composition of the present embodiment is preferably 3.0 or more and 10.0 or less, more preferably 4.0 or more and 9.0 or less, even more preferably 4.5 or more and 8.0 or less, particularly preferably 5.0 or more and 8.0 or less, and most preferably 6.0 or more and 8.0 or less.

When the ratio (C/N) of the number of carbon atoms C to the number of nitrogen atoms N in the (B) crystalline semi-aromatic polyamide is within the above range, a polyamide composition excellent in heat resistance and compressive strength can be obtained. Moreover, the molded article obtained from the polyamide composition tends to have a better surface appearance.

In addition, the difference between the melting point peak temperature of the (A) crystalline aliphatic polyamide and the melting point peak temperature of the (B) crystalline semi-aromatic polyamide is preferably 40° C. or higher, more preferably 50° C. or higher, even more preferably 55° C. or higher, particularly preferably 60° C. or higher, and most preferably 65° C. or higher.

When the difference in melting point peak temperature between the (A) component and the (B) component is equal to or greater than the above lower limit, the melting point depression effect becomes significant, enabling processing at lower temperatures than conventional processing temperatures. As a result, mechanical properties such as compressive strength and toughness tend to be improved, and the thermal expansion rate also tends to be improved. Further, the molded article obtained from the polyamide resin composition tends to have a better surface appearance.

<(C) Modified Elastomer Having Reactive Functional Group Capable of Reacting with End Group and/or Main Chain Amide Bond of Polyamide Resin>

The polyamide resin composition of the present embodiment contains (C) a modified elastomer having a reactive functional group capable of reacting with end group and/or main chain amide bond of the polyamide resin (hereinafter also referred to as “(C) modified elastomer”), in addition to the (A) aliphatic polyamide and the (B) crystalline semi-aromatic polyamide.

The (C) modified elastomer is not particularly limited, but it is preferably an elastomer modified with a dicarboxylic acid such as maleic acid or itaconic acid, or anhydrides thereof, because they have better mechanical properties.

The (C) modified elastomer preferably has at least one component derived from an olefin compound in the constituent components thereof, and the main chain of the modified elastomer is preferably an unsaturated hydrocarbon structure and/or a saturated hydrocarbon structure obtained by reducing the unsaturated hydrocarbon, represented by CmHn (where m and n are natural numbers).

The (C) modified elastomer preferably has a content ratio of the component derived from the olefin compound of 50% or more, more preferably 60% or more, even more preferably 70% or more, and particularly preferably 80% or more.

The (C) modified elastomer preferably has a surface hardness of 90 or less, more preferably 80 or less, and even more preferably 70 or less, as measured by a test method in accordance with ISO-7619 or ASTM D2240.

In the polyamide resin composition of the present embodiment, the content of the (C) modified elastomer relative to the total mass of the resin composition is preferably 0.1 mass % or more and 15 mass % or less, more preferably 1 mass % or more and 15 mass % or less, and particularly preferably 5 mass % or more and 10 mass % or less.

In the polyamide resin composition of the present embodiment, the content of the (C) modified elastomer relative to the total mass of the resin composition is preferably 0.1 mass % or more and 15 mass % or less, more preferably 1 mass % or more and 15 mass % or less, and particularly preferably 5 mass % or more and 10 mass % or less.

Further, in the polyamide resin composition of the present embodiment, the content of the (C) modified elastomer relative to the total content of the polyamide resin ((A) crystalline aliphatic polyamide and (B) crystalline semi-aromatic polyamide) [(C)/((A)+(B))] is preferably 0.10 or more and 0.50 or less, more preferably 0.10 or more and 0.30 or less, and even more preferably 0.10 or more and 0.20 or less, in mass ratio.

When the content of the (C) modified elastomer is within the above range, it is possible to enhance the thermal expansion rate and wear resistance while maintaining excellent mechanical properties such as heat resistance and compressive strength in the molded article obtained from the polyamide resin composition.

### <(D) Fibrous Reinforcing Filler>

The polyamide resin composition of the present embodiment further contains (D) a fibrous reinforcing filler, in addition to the above-mentioned components (A) to (C). By containing the (D) fibrous reinforcing filler, a polyamide resin composition excellent in compressive strength and toughness can be obtained.

Here, the (D) fibrous reinforcing filler preferably has an average fiber diameter (d) of 1 μm or more and 30 μm or less, more preferably 2 μm or more and 30 μm or less. Additionally, the weight-average fiber length (L) is preferably 0.1 mm or more and 5.0 mm or less, more preferably 0.5 mm or more and 4.0 mm or less. Furthermore, the aspect ratio ((L)/(d)) is preferably 3 or more and 100 or less.

The (D) fibrous reinforcing filler is not particularly limited, but is preferably glass fiber, carbon fiber, or aramid fiber.

These fibrous reinforcing fillers may be used alone or in combination of two or more.

Among them, from the viewpoint of compressive strength, toughness, and the surface appearance of molded articles, glass fiber is particularly preferable as the (D) fibrous reinforcing filler.

The average fiber diameter and weight-average fiber length of the (D) fibrous reinforcing filler can be measured by the following method.

First, a molded article of the polyamide composition is subjected to a high temperature of 450° C. or higher to melt the resin components. Next, for example, 100 or more glass fibers are arbitrarily selected from the resulting ash components. Then, the glass fibers can be observed under an optical microscope or a scanning electron microscope or the like.

In the polyamide resin composition of the present embodiment, the content of the (D) fibrous reinforcing filler in the polyamide resin composition is preferably 5 mass % or more and 50 mass % or less, more preferably 10 mass % or more and 40 mass % or less, and particularly preferably 15 mass % or more and 30 mass % or less, relative to the total mass of the polyamide resin composition.

When the content of the (D) fibrous reinforcing filler is within the above range, the compressive resistance characteristics and the physical property retention rate upon water absorption of the polyamide resin composition tend to be further improved. In addition, a polyamide resin composition excellent in surface appearance of the molded article and excellent in wear resistance can be obtained.

### <(E) Other Additives>

The polyamide composition of the present embodiment may also contain (E) other additives within a range that does not impair the effects of the polyamide composition of the present embodiment, in addition to the above components (A) to (D). Examples of the (E) other additives include (E-1) moldability improving agents (hereinafter also referred to as “lubricants”), (E-2) degradation inhibitors, (E-3) nucleating agents, and (E-4) heat stabilizers.

Further, when the polyamide resin composition of the present embodiment contains (E) other additives, the content of the (E) other additives in the polyamide composition of the present embodiment may vary depending on the type or the use of the polyamide composition, and is not particularly limited as long as the effects of the polyamide composition of the present embodiment are not impaired. For example, the content is preferably 5 mass % or less, more preferably 3 mass % or less, still more preferably 2 mass % or less, and particularly preferably 1 mass % or less, relative to the total mass of the polyamide resin composition.

### ((E-1) Moldability Improving Agents)

The (E-1) moldability improving agents that may be contained in the polyamide composition of the present embodiment are not particularly limited, and examples include higher fatty acids, metal salts of higher fatty acids, higher fatty acid esters, and higher fatty acid amides.

### ((E-2) Degradation Inhibitors)

The (E-2) degradation inhibitors that may be contained in the polyamide composition of the present embodiment are used for the purpose of preventing thermal degradation, discoloration under heat, and improving heat aging resistance.

Although the (E-2) degradation inhibitors are not particularly limited, examples include copper compounds, phenolic stabilizers, phosphite-based stabilizers, hindered amine-based stabilizers, triazine-based stabilizers, benzotriazole-based stabilizers, benzophenone-based stabilizers, cyanoacrylate-based stabilizers, salicylate-based stabilizers, and sulfur-based stabilizers.

Here, examples of the copper compounds include copper acetate and copper iodide.

Furthermore, examples of the phenolic stabilizers include hindered phenol compounds.

These (E-2) degradation inhibitors may be used alone as a single type, or in combination of two or more types.

### ((E-3) Nucleating Agents)

It should be noted that (E-3) a nucleating agent refers to a substance that, when added, provides at least one of the following effects:
(1) the effect of increasing the crystallization peak temperature of the polyamide composition;
(2) the effect of reducing the difference between the extrapolated onset and extrapolated end temperatures of the crystallization peak; and
(3) the effect of refining or uniformizing the sizes of crystal spheres in the resulting molded article.

Examples of the (E-3) nucleating agents include the following, but are not limited to, talc, boron nitride, mica, kaolin, silicon nitride, carbon black, potassium titanate, and molybdenum disulfide.

One of the (E-3) nucleating agents may be used alone, or two or more of these may be used in combination.

For achieving better effects of nucleating agents, the number-average particle size of the (E-3) nucleating agents is preferably 0.01 μm or more and 10 μm or less.

The number-average particle size of the nucleating agents can be measured using the following method. First, a molded article is dissolved in a solvent such as formic acid, which dissolves the polyamide. Next, from the obtained insoluble fractions, 100 or more nucleating agent particles are randomly selected. The particle sizes of the nucleating agent particles are then measured using an optical microscope or a scanning electron microscope.

### ((E-4) Heat Stabilizers)

Examples of (E-4) heat stabilizers are not limited to the following but include phenolic heat stabilizers, phosphorus-based heat stabilizers, amine-based heat stabilizers, metal salts of elements in Groups 3, 4, and 11-14 of the Periodic Table of Elements, and alkali metal and alkaline earth metal halides, for example.

One of these (E-4) heat stabilizers may be used alone, or two or more of these may be used in combination.

The content of the heat stabilizer in the polyamide resin composition of the present embodiment is preferably 1.0 mass % or less, and more preferably 0.1 mass % or more and 1.0 mass % or less, relative to the total mass of the polyamide composition.

When the content of the heat stabilizer is within the above range, the heat aging resistance of the polyamide composition can be further improved, and the amount of generated gas can be further reduced.

### <Coloring Agent>

The coloring method of the polyamide resin composition of the present embodiment is not particularly limited, and it is possible to use at least one coloring agent selected from known organic and inorganic pigments.

Examples of the organic pigments include azo pigments such as azo lake pigments, benzimidazolone pigments, diarylide pigments, and condensed azo pigments, phthalocyanine pigments such as phthalocyanine blue and phthalocyanine green, condensed polycyclic pigments such as isoindolinone pigments, quinophthalone pigments, quinacridone pigments, perylene pigments, anthraquinone pigments, perinone pigments, and dioxazine violet, azine pigments, and carbon black.

Examples of the inorganic pigments include metal oxides other than iron oxide such as titanium oxide, zinc oxide and chromium oxide, and composite metal oxides such as titan yellow, cobalt blue, and ultramarine.

The preferred amount of the coloring agent to be added is not particularly limited, but it is preferably 10 mass % or less, more preferably 5 mass % or less, still more preferably 2 mass % or less, and particularly preferably 1 mass % or less, relative to the total mass of the polyamide resin composition.

By adding the coloring agent in the above range, it is possible to maintain a good balance of properties such as heat resistance, compressive resistance, thermal expansion rate, and wear resistance. Furthermore, excellent moldability during injection molding can be achieved, and molded articles with a more excellent surface appearance can be obtained.

### <Method for Producing Polyamide Resin Composition>

The method for producing the polyamide composition of the present embodiment is not particularly limited as long as the method includes mixing the (A) crystalline aliphatic polyamide, the (B) crystalline semi-aromatic polyamide, the (C) modified elastomer, and the (D) fibrous reinforcing filler, and if necessary, the above component (E).

Examples of the method for mixing the above components (A) to (D) and, if necessary, the above component (E) include the following methods (1) or (2):
(1) A method in which the above components (A) to (D) and, if necessary, the above component (E) are mixed using a Henschel mixer or the like, supplied to a melt-kneading machine, and kneaded.
(2) A method in which a mixture containing the above components (A) to (C) and, if necessary, the above component (E) is prepared by preliminarily mixing the above components (A) to (D) and, if necessary, the above component (E) using a single-screw or twin-screw extruder or the like, the mixture is supplied to a melt-kneading machine and kneaded, and then optionally, the component (D) is added from a side feeder.

The method for feeding the components of the polyamide composition to the melt-kneader may be accomplished by feeding all the components at once to the same feed port, or by feeding the components from different feed ports.

The temperature of the melt kneading is preferably a temperature higher than the melting point of the (B) crystalline semi-aliphatic polyamide by about 1° C. or higher and 50° C. or lower, and is more preferably a temperature higher than the melting point of the (B) crystalline semi-aliphatic polyamide by about 10° C. or higher and 30° C. or lower.

The shear rate in the kneader is preferably about 100 sec⁻¹ or higher. The average residence time of kneading is preferably 0.5 minutes or longer and 5 minutes or shorter.

Any apparatus for performing melt-kneading may be used, and single or twin screw extruders, Banbury mixers, melt kneaders (mixing rolls, etc.), and like are preferably used, for example.

The amounts of the respective components in the polyamide composition of the present embodiment are the same as the amounts of the respective components in the polyamide composition described above.

### <Properties of Polyamide Resin Composition>

### (Linear Expansion Coefficient of Polyamide Resin Composition)

The polyamide resin composition of the present embodiment has, in a test piece of 10×5×4 mm cut out from an ISO test piece, a linear expansion coefficient of at least one of the flow direction of the resin (hereinafter referred to as MD), the direction perpendicular thereto (hereinafter referred to as TD), or the thickness direction of the test piece (hereinafter referred to as ND), measured by the method described below, of preferably 10×10⁻⁵/K or more, more preferably 15×10⁻⁵/K or more, and even more preferably 20×10⁻⁵/K or more. Moreover, the average value of the two larger linear expansion coefficients among the linear expansion coefficients in MD, TD, and ND is preferably 10×10⁻⁵/K or more, more preferably 12×10⁻⁵/K or more, and even more preferably 15×10⁻⁵/K or more. Furthermore, the average value of the linear expansion coefficients in MD, TD, and ND is preferably 8×10⁻⁵/K or more, more preferably 9×10⁻⁵/K or more, and even more preferably 10×10⁻⁵/K or more. Most preferably, among the linear expansion coefficients in MD, TD, and ND, at least one is 15×10⁻⁵/K or more, the average value of the two larger linear expansion coefficients is 12×10⁻⁵/K or more, and the average value of all three is 9×10⁻⁵/K or more.

When the linear expansion coefficients of the polyamide resin composition are equal to or greater than the above values, a molded article obtained from the polyamide resin composition can be used as a composite material with metal parts in industrial applications, automotive applications, and robotic applications without generating a gap at high temperatures, thereby enabling stable operation of devices.

### (Compressive Strength of Polyamide Resin Composition)

The 5% compressive strength (compressive strength when 5% strain is applied) in a compression test at 120° C. using a test piece of 10×10×4 mm cut out from an ISO test piece of the polyamide resin composition of the present embodiment, measured by the method described below. is preferably 5.0 MPa or more, more preferably 10 MPa or more, and even more preferably 15 MPa or more. Moreover, the strain of the test piece at a compressive stress of 100 MPa is preferably 60% or less, more preferably 55% or less, even more preferably 50% or less, and particularly preferably 45% or less.

(Melting point Tm of Polyamide Resin Composition)

The polyamide resin composition of the present embodiment preferably has two melting points Tm. Among the above melting points, the lower melting point Tm-1 is preferably 200° C. or higher and 290° C. or lower, more preferably 220° C. or higher and 280° C. or lower, even more preferably 230° C. or higher and 270° C. or lower, and particularly preferably 240° C. or higher and 260° C. or lower.

The higher melting point Tm-2 is preferably 290° C. or higher and 360° C. or lower, more preferably 300° C. or higher and 350° C. or lower, and even more preferably 310° C. or higher and 340° C. or lower.

Furthermore, the difference between the two melting points (ΔTm) is preferably 20° C. or higher, more preferably 30° C. or higher, even more preferably 40° C. or higher, and particularly preferably 50° C. or higher and 100° C. or lower.

### [Molded Article]

The molded article of the present embodiment includes the polyamide resin composition of the present embodiment mentioned above.

The method for obtaining the molded article of the present embodiment is not particularly limited, and known molding methods can be used.

Examples of known molding methods include extrusion molding, injection molding, vacuum molding, blow molding, injection compression molding, decoration molding, dual injection molding, gas-assisted injection molding, foaming injection molding, low-pressure molding, ultrathin injection molding (ultrahigh-speed injection molding), and in-mold composite molding (insert molding and outsert molding).

The molded article of the present embodiment is excellent in heat resistance, compressive resistance characteristics, toughness, thermal expansion rate, and wear resistance, and also excellent in physical property retention rate upon water absorption, and thus can be suitably used in applications such as automobiles, electrical and electronic materials, industrial equipment, office equipment, and daily goods and household items.

### Examples

The following provides a more detailed description of the present disclosure through specific examples and comparative examples. However, the present disclosure is not limited to the following examples.

### <Components>

In the following, each component of the polyamide resin compositions used in the examples and comparative examples will be described.

### [(A) Crystalline Aliphatic Polyamide]

A-1: Polyamide 66 (melting point: 260° C.) prepared under the following conditions.
A-2: Polyamide 610 (melting point: 225° C.) prepared under the following conditions.

Note that each of the polyamides obtained by the following conditions was dried in a nitrogen stream to adjust the moisture content to about 0.2 mass %, and then was used as a raw material for polyamide resin compositions in the examples and comparative examples described below.

### ((A-1) Preparation of Polyamide 66)

First, a 50 mass % homogeneous equimolar water solution of raw monomers was prepared by dissolving 1500 g of an equimolar salt of adipic acid and hexamethylenediamine in 1500 g of distilled water. The water solution was charged in an autoclave with a content of 5.4 L, which was replaced with nitrogen. Next, the solution was concentrated by gradually venting water vapor until the concentration of the solution reached 70 mass % while stirring at a temperature of 110° C. or higher and 150° C. or lower. The internal temperature was then raised to 220° C. At this time, the pressure of the autoclave was increased to 1.8 MPa. A reaction was caused to take place for 1 hour while the pressure was maintained at 1.8 MPa until the internal temperature reached 245° C. by gradually venting water vapor for 1 hour. The pressure was then lowered over 1 hour. The interior of the autoclave was then maintained to a reduced pressure of 650 torr (86.66 kPa) for 10 minutes using a vacuum apparatus. At this time, the final internal temperature of the polymerization was 265° C. The resultant was then extruded by pressurization with nitrogen through a lower spinneret (nozzle) into strands, which were water-cooled, cut, and discharged in the form of pellets, and dried at 100° C. under a nitrogen atmosphere for 12 hours to obtain (A-1) a crystalline aliphatic polyamide (polyamide 66).

((A-2) Preparation of Polyamide 610) First, a uniform aqueous solution of the raw material monomers was prepared by dissolving 1500 g of equimolar salt of sebacic acid and hexamethylenediamine was in 1800 g of distilled water. The water solution was charged in an autoclave with a content of 5.4 L, which was replaced with nitrogen.

The solution was concentrated by gradually venting water vapor until the concentration of the solution reached 70 mass % while stirring at a temperature of 110 to 150° C. The internal temperature was then raised to 220° C. At this time, the pressure of the autoclave was increased to 1.8 MPa. A reaction was caused to take place for 1 hour while the pressure was maintained to 1.8 MPa until the internal temperature reached 245° C. by gradually venting water vapor for 1 hour.

The pressure was then lowered over 1.5 hours. The interior of the autoclave was then maintained to a reduced pressure of 650 torr for 10 minutes using a vacuum apparatus. At this time, the final internal temperature of the polymerization was 265° C.

The resultant was then extruded by pressurization with nitrogen through a lower spinneret (nozzle) into strands, which were water-cooled, cut, and discharged in the form of pellets, and dried at 100° C. under a nitrogen atmosphere for 12 hours to obtain (A-2) a crystalline aliphatic polyamide (polyamide 610).

### (B) Crystalline Semi-Aromatic Polyamide

B-1: Polyamide 4T/6T copolymer (melting point: 345° C.) prepared under the following conditions
B-2: Polyamide 9T (manufactured by Kuraray, Co., Ltd., melting point: 305° C.)
B-3: Polyamide 6T/6I (70/30 mol %) (manufactured by EMS, melting point: 325° C.)

The (B-1) polyamide 4T/6T copolymer prepared under the following conditions was dried under a nitrogen stream so as to adjust the moisture content to about 0.2 mass %, and was then used as a raw material for the polyamide resin composition in the examples and comparative examples described later.

### ((B-1) Preparation of Polyamide 4T/6T Copolymer)

To a 50-liter rotary dryer, 1500 g of 4T/6T salts (38 mol %/62 mol %) was added, the dryer was evacuated to 50 mbar and filled with nitrogen. After repeating the above operation five times, the mixture was heated to 220° C. over 5 hours while discharging the reaction water out of the system, and then further heated to 255° C. over 15 hours. A mixture of 65 g of 1,6-hexamethylenediamine, 30 g of 1,4-butanediamine, and 100 g of water was added over 7 hours under nitrogen purging. Further, the mixture was reacted at 235° C. for 29 hours under a nitrogen atmosphere and cooled to room temperature, to yield a white powder (B-1 polyamide 4T/6T copolymer). [0109](C) Modified Elastomer
C-1: Maleic anhydride-modified polyethylene (FUSABOND M603)
C-2: Maleic anhydride-modified ethylene-butene copolymer (Tafmer MH5020)
C-3: Maleic anhydride-modified ethylene-octene copolymer (TAPOE1002CM)
C-4: Maleic anhydride-modified styrene-ethylene-butylene-styrene copolymer (Tuftec M1943)
C-5: Unmodified low-density polyethylene

### (D) Fibrous Reinforcing Filler

D-1: Glass fiber (ECS03T-275H manufactured by Nippon Electric Glass Co., Ltd.)

### ((i) Other Additives)

E-1: IRGANOX 1098 (antioxidant)

### Examples 1 to 12 and Comparative Examples 1 to 7

A twin-screw extruder with 12 barrels, having an upstream feed port in the first barrel on the upstream side from the extruder, a downstream feed port in the eighth barrel, and a vacuum vent in the eleventh barrel, and having an L/D (length/diameter of the extruder cylinder) of 48 was used. The (A) crystalline aliphatic polyamide, the (B) crystalline semi-aromatic polyamide, and the (C) modified elastomer, and if necessary, (E) other additives, were fed from the top feed port provided at the most upstream part of the extruder.

Further, the (D) fibrous reinforcing filler was fed from the side feed port located downstream of the extruder (where the resin fed from the top feed port was sufficiently melted), and melt-kneading was performed under reduced pressure via the vacuum vent. The barrel temperature was set to be 10° C. or higher and 30° C. or lower above the melting point of the (B) crystalline semi-aromatic polyamide.

Next, the melt-kneaded mixture extruded from the die head was cooled into strands and pelletized to obtain polyamide composition pellets. The twin-screw extruder is not particularly limited, but ZSK-26MC manufactured by Coperion (Germany) is preferable.

The types of the respective components used in the production of the polyamide resin composition were as described below, and the compounding amounts of each component are summarized in Table 1.

### Example 1

The (A-1) crystalline aliphatic polyamide, the (B-1) crystalline semi-aromatic polyamide, the (C-1) modified elastomer, and the (D) fibrous reinforcing filler were mixed in the compounding amounts summarized in Table 1 below in accordance with the above-described production method to obtain pellets of the polyamide resin composition.

### Examples 2 to 6

Pellets of the polyamide resin composition were obtained under similar conditions to those in Example 1, except that the contents of the (A-1) crystalline aliphatic polyamide, the (B-1) crystalline semi-aromatic polyamide, the (C-1) modified elastomer, and the (D) fibrous reinforcing filler were changed as summarized in Table 1 below.

### Example 7

Pellets of the polyamide resin composition were obtained under similar conditions to those in Example 1, except that the (B-2) crystalline semi-aromatic polyamide was used instead of the (B-1).

### Example 8

Pellets of the polyamide resin composition were obtained under similar conditions to those in Example 1, except that the (B-3) crystalline semi-aromatic polyamide was used instead of the (B-1).

### Example 9

Pellets of the polyamide resin composition were obtained under similar conditions to those in Example 1, except that the (C-2) modified elastomer was used instead of the (C-1).

### Example 10

Pellets of the polyamide resin composition were obtained under similar conditions to those in Example 1, except that the (C-3) modified elastomer was used instead of the (C-1).

### Example 11

Pellets of the polyamide resin composition were obtained under similar conditions to those in Example 1, except that the (C-4) modified elastomer was used instead of the (C-1).

### Example 12

Pellets of the polyamide resin composition were obtained under similar conditions to those in Example 1, except that the (A-2) crystalline aliphatic polyamide was used instead of the (A-1).

### Comparative Example 1

Pellets of the polyamide resin composition were obtained by mixing the (B-1) crystalline semi-aromatic polyamide, the (C-1) modified elastomer, and the (D) fibrous reinforcing filler in the compounding amounts summarized in Table 1 below, without using the (A) crystalline aliphatic polyamide.

### Comparative Example 2

Pellets of the polyamide resin composition were obtained by mixing the (A-1) crystalline aliphatic polyamide, the (B-1) crystalline semi-aromatic polyamide, and the (C-1) modified elastomer in the compounding amounts summarized in Table 1 below, without using the (D) fibrous reinforcing filler.

### Comparative Example 3

Pellets of the polyamide resin composition were obtained by mixing the (A-1) crystalline aliphatic polyamide, the (C-1) modified elastomer, and the (D) fibrous reinforcing filler in the compounding amounts summarized in Table 1 below, without using the (B-1) crystalline semi-aromatic polyamide.

### Comparative Examples 4 to 5

Pellets of the polyamide resin composition were obtained in a manner similar to Example 1, except that the contents of the (A-1) crystalline aliphatic polyamide, the (B-1) crystalline semi-aromatic polyamide, the (C-1) modified elastomer, and the (D) fibrous reinforcing filler were changed as summarized in Table 1 below, and various physical property measurements and evaluations were conducted.

### Comparative Example 6

Pellets of the polyamide resin composition were obtained by mixing the (A-1) crystalline aliphatic polyamide, the (B-1) crystalline semi-aromatic polyamide, and the (D) fibrous reinforcing filler in the compounding amounts summarized in Table 1 below, without using the (C-1) modified elastomer.

### Comparative Example 7

Pellets of the polyamide resin composition were obtained under similar conditions to those in Example 1, except that the (C-5) unmodified olefin resin was used instead of the (C-1).

### <Physical Properties and Evaluations>

Molded articles were produced using the samples of the polyamide composition obtained in the above Examples and Comparative Examples, and various physical property measurements and evaluations were conducted.

First, the pellets of the polyamide resin composition obtained in the Examples and Comparative Examples were dried under a nitrogen stream. Thereafter, the pellets of each polyamide resin composition with adjusted moisture content were used to conduct evaluations of various properties by the following methods.

### [Production of Molded Article]

The molded articles used in each of the evaluations of the properties and the tests were produced using the following method.

The apparatus used was either “NEX-50II” or “NEX-50IV” manufactured by Nissei Plastic Industrial Co., Ltd. The cylinder temperature was set at 290° C., the mold temperature at 120° C., and molded articles (ISO test specimens) were obtained by performing injection molding up to 100 shots using each polyamide composition under the conditions of 10 seconds for injection and 10 seconds for cooling.

### (1) Surface Appearance Evaluation of Molded Article

The appearance of the molded article obtained as described above was evaluated comprehensively based on surface gloss value, sink marks, blemishes, silver streaks, and other defects on the molded surface.

### (Evaluation Criteria)

A (Excellent): The surface gloss value was 60 or more, and no sink marks or exposure of glass fiber were observed on the molded surface.

B (Good): The surface gloss value was 55 or more, and slight sink marks or exposure of glass fiber were observed on the molded surface.
C (Fair): The surface gloss value was 50 or more, and sink marks or exposure of glass fiber were observed on the molded surface.
D (Poor): The surface gloss value was less than 50, and sink marks or exposure of glass fiber were prominent on the molded surface.

### (2) Compressive Strength and Compressive Strain

Test pieces of 10 mm square were cut out from the ISO test pieces of 20 to 30 shots obtained as described above, and the compressive strength, compressive strain, and 5% compressive yield strength at 120° C. were measured in accordance with ISO 604. Here, the 5% compressive yield strength refers to the compressive strength when the compressive strain reaches 5%, and the higher this value, the better the compressive resistance.

### (3) Linear Expansion Coefficient

Test pieces of 10×5×4 mm were cut out from the ISO test pieces of 20 to 30 shots obtained in the above “Manufacturing of Molded Article,” and the linear expansion coefficient upon heating from −40° C. to 150° C. was measured in accordance with JIS K 7197.

### (Measurement Conditions)

Instrument: TMA7100 thermal mechanical analyzer (manufactured by Hitachi
High-Technologies Corporation)
Measurement mode: Expansion
Heating rate: 5° C./min
Measurement temperature range: −40° C. to 150° C.

### (4) Physical Property Retention Rate Upon Water Absorption

A tensile test was performed using the ISO test pieces from 20 to 30 shots as obtained above at a tensile speed of 5 mm/min in accordance with ISO 527 to measure the tensile strength (MPa). In this test, ISO test specimens that were conditioned for 24 hours at 23° C. and 50%±10% RH after molding were denoted as “Dry”, and ISO test specimens of which water absorption rate were conditioned under the conditions in accordance with JIS K 7143 were denoted as “Wet”. The physical property retention rate ((“Dry”−“Wet”)/“Dry”×100) was calculated based on the value of tensile strength of “Wet” relative to the value of the tensile strength of “Dry”.

### (5) Charpy Impact Strength

Test samples of 80×10×4 mm were cut out from the ISO test specimens from 20 to 30 shots obtained in the above “Production of Molded Article”, and the notched Charpy impact strength was measured in accordance with ISO 179.

### (6) Sliding Characteristics (Coefficient of Friction, Wear Depth)

A reciprocating sliding test was conducted using the ISO test specimens from 20 to 30 shots obtained in the above “Production of Molded Article”.

### (Measurement Method)

A sliding test was performed using a reciprocating friction and wear tester (Model AFT-15MS, manufactured by Toyo Seimitsu Co., Ltd.) and a SUS304 test piece (a ball with a diameter of 5 mm) as the counter material under a linear speed of 50 mm/sec, a reciprocating stroke of 20 mm, a temperature of 23° C., and a humidity of 50%. Furthermore, a coefficient of friction test was conducted under a load of 4 kg and 10,000 reciprocating cycles. In addition, the maximum wear depth of the wear scar on the sample after the sliding test was measured using a surface roughness tester (Model 575A-30 manufactured by Toyo Seimitsu Co., Ltd.).

TABLE 1

| | | | | Example | Example | Example | Example | Example | Example | Example |
|---|---|---|---|---|---|---|---|---|---|---|
| | Type | | Unit | 1 | 2 | 3 | 4 | 5 | 6 | 7 |
| Chemical | A-1 | 66 | mass % | 52.5 | 47.0 | 63.7 | 52.0 | 54.0 | 40.5 | 52.5 |
| composition | A-2 | 610 | mass % | — | — | — | — | — | — | — |
| | B-1 | TD 100 (4T/6T) | mass % | 22.5 | 28.0 | 11.3 | 9.0 | 9.5 | 8.0 | — |
| | B-2 | 9T | mass % | — | — | — | — | — | — | 22.5 |
| | B-3 | 6T/6I (Arlen_A3000) | mass % | — | — | — | — | — | — | — |
| | C-1 | FUSABOND M603 (m-PE) | mass % | 10.0 | 10.0 | 10.0 | 9.0 | 6.5 | 6.5 | 10.0 |
| | C-2 | Tafmer MD715 (m-EBR) | mass % | — | — | — | — | — | — | — |
| | C-3 | TSPOE1002CM (m-EOR) | mass % | — | — | — | — | — | — | — |
| | C-4 | Tuftek M 1943 (m-SEB S) | mass % | — | — | — | — | — | — | — |
| | C-5 | Unmodified PE | mass % | — | — | — | — | — | — | — |
| | D-1 | T-275H | mass % | 15.0 | 15.0 | 15.0 | 30.0 | 30.0 | 45.0 | 15.0 |
| | (B)/[(A) + (B)] | | | 0.30 | 0.37 | 0.15 | 0.15 | 0.15 | 0.16 | 0.30 |
| | (C)/[(A) + (B)] | | | 0.133 | 0.133 | 0.133 | 0.148 | 0.102 | 0.134 | 0.133 |
| | Sum | | mass % | 100.0 | 100.0 | 100.0 | 100.0 | 100.0 | 100.0 | 100.0 |
| Evaluation of | (2) Compressive strength | 120° C. Strength | MPa | 184.0 | 205.00 | 241.00 | 242.00 | 237.00 | 258.00 | 210.00 |
| Properties | | 5% compressive yield strength | MPa | 18.4 | 17.60 | 16.90 | 17.20 | 19.90 | 21.40 | 18.00 |
| | | 120° C. strain at 100 MPa | | 47.90 | 46.50 | 49.80 | 47.80 | 47.80 | 37.50 | 44.50 |
| | (3) Linear expansion Coefficient | TD | | 13.2 | 14.2 | 14.8 | 14.3 | 131 | 12.6 | 15.8 |
| | | MD | | 2.9 | 2.9 | 3.0 | 2.2 | 2.5 | 2.3 | 3.1 |
| | | ND | | 20.4 | 19.8 | 22.6 | 20.1 | 19.2 | 19.5 | 21.5 |
| | (4) Retention rate of | Wet/Dry tension at 23° C. | % | 84.0 | 89.0 | 82.0 | 82.0 | 84.0 | 87.0 | 88.0 |
| | property upon water | | | | | | | | | |
| | absorption | | | | | | | | | |
| | (5) Charpy Impact strength | | KJ/m2 | 6.4 | 6.9 | 8.0 | 12.9 | 16.1 | 17.0 | 5.9 |
| | (6) Sliding characteristic | Coefficient of friction | — | 0.15 | 0.12 | 0.14 | 0.15 | 0.14 | 0.18 | 0.17 |
| | | Wear depth | μm | 4.7 | 4.5 | 4.7 | 520 | 540 | 950 | 4.4 |
| | (1) Surface appearance evaluation | | | A | A | A | A | A | B | A |
| | of molded article | | | | | | | | | |
| | | | | | Example | Example | Example | Example | Example | Comp |
| | | Type | | Unit | 8 | 9 | 10 | 11 | 12 | Ex. 1 |
| | Chemical | A-1 | 66 | mass % | 52.5 | 52.5 | 63.7 | 52.5 | — | — |
| | composition | A-2 | 610 | mass % | — | — | — | — | 63.7 | — |
| | | B-1 | TD 100 (4T/6T) | mass % | — | 22.5 | 11.3 | 22.5 | 11.3 | 75.0 |
| | | B-2 | 9T | mass % | — | — | — | — | — | — |
| | | B-3 | 6T/6I (Arlen_A3000) | mass % | 22.5 | — | — | — | — | — |
| | | C-1 | FUSABOND M603 (m-PE) | mass % | 10.0 | — | — | — | 10.0 | 10.0 |
| | | C-2 | Tafmer MD715 (m-EBR) | mass % | — | 10.0 | — | — | — | — |
| | | C-3 | TSPOE1002CM (m-EOR) | mass % | — | — | 10.0 | — | — | — |
| | | C-4 | Tuftek M 1943 (m-SEB S) | mass % | — | — | — | 10.0 | — | — |
| | | C-5 | Unmodified PE | mass % | — | — | — | — | — | — |
| | | D-1 | T-275H | mass % | 15.0 | 15.0 | 15.0 | 15.0 | 15.0 | 15.0 |
| | | (B)/[(A) + (B)] | | | 0.30 | 0.30 | 0.15 | 0.30 | 0.15 | 1.00 |
| | | (C)/[(A) + (B)] | | | 0.133 | 0.133 | 0.133 | 0.133 | 0.133 | 0.133 |
| | | Sum | | mass % | 100.0 | 100.0 | 100.0 | 100.0 | 100.0 | 100.0 |
| | Evaluation of | (2) Compressive strength | 120° C. Strength | MPa | 209.00 | 132.00 | 125.00 | 123.00 | 109.00 | 142.00 |
| | Properties | | 5% compressive yield strength | MPa | 17.00 | 17.20 | 15.90 | 18.20 | 15.20 | 27.20 |
| | | | 120° C. strain at 100 MPa | | 49.20 | 54.70 | 53.90 | 45.80 | 50.90 | 39.60 |
| | | (3) Linear expansion Coefficient | TD | | 13.8 | 9.7 | 14.3 | 12.9 | 14.5 | 7.5 |
| | | | MD | | 2.6 | 2.3 | 3.4 | 2.3 | 2.5 | 2.4 |
| | | | ND | | 19.9 | 15.1 | 22.6 | 15.8 | 20.2 | 11.5 |
| | | (4) Retention rate of | Wet/Dry tension at 23° C. | % | 80.0 | 81.0 | 83.0 | 80.0 | 89.0 | 91.0 |
| | | property upon water | | | | | | | | |
| | | absorption | | | | | | | | |
| | | (5) Charpy Impact strength | | KJ/m2 | 8.1 | 13.1 | 9.5 | 8.6 | 10.7 | 5.6 |
| | | (6) Sliding characteristic | Coefficient of friction | — | 0.15 | 0.15 | 0.22 | 0.20 | 0.15 | 0.15 |
| | | | Wear depth | μm | 4.9 | 10.2 | 54.0 | 55.0 | 10.0 | 4.6 |
| | | (1) Surface appearance evaluation | | | A | A | A | A | A | A |
| | | of molded article | | | | | | | | |
| | | | | | Comp. | Comp. | Comp. | Comp. | Comp. | Comp. |
| | | Type | | Unit | Ex. 2 | Ex. 3 | Ex. 4 | Ex. 5 | Ex 6 | Ex 7 |
| | Chemical | A-1 | 66 | mass % | 61.5 | 75.0 | 32.6 | 55.5 | 59.5 | 52.5 |
| | composition | A-2 | 610 | mass % | — | — | — | — | — | — |
| | | B-1 | TD 100 (4T/6T) | mass % | 26.5 | — | 42.4 | 9.5 | 25.5 | 22.5 |
| | | B-2 | 9T | mass % | — | — | — | — | — | — |
| | | B-3 | 6T/6I (Arlen_A3000) | mass % | — | — | — | — | — | — |
| | | C-1 | FUSABOND M603 (m-PE) | mass % | 12.0 | 10.0 | 10.0 | 20.0 | — | — |
| | | C-2 | Tafmer MD715 (m-EBR) | mass % | — | — | — | — | — | — |
| | | C-3 | TSPOE1002CM (m-EOR) | mass % | — | — | — | — | — | — |
| | | C-4 | Tuftek M 1943 (m-SEB S) | mass % | — | — | — | — | — | — |
| | | C-5 | Unmodified PE | mass % | — | — | — | — | — | 10.0 |
| | | D-1 | T-275H | mass % | | 15.0 | 15.0 | 15.0 | 15.0 | 15.0 |
| | | (B)/[(A) + (B)] | | | 0.30 | 0.00 | 0.57 | 0.15 | 0.30 | 0.30 |
| | | (C)/[(A) + (B)] | | | 0.136 | 0.133 | 0.133 | 0.308 | 0.000 | 0.133 |
| | | Sum | | mass % | 100.0 | 100.0 | 100.0 | 100.0 | 100.0 | 100.0 |
| | Evaluation of | (2) Compressive strength | 120° C. Strength | MPa | <100 | <100 | 240.00 | <100 | 227.00 | 176.00 |
| | Properties | | 5% compressive yield strength | MPa | 14.60 | 15.70 | 20.90 | 13.50 | 18.50 | 18.70 |
| | | | 120° C. strain at 100 MPa | | 47.37 | 56.50 | 39.60 | 57.80 | 36.70 | 49.20 |
| | | (3) Linear expansion Coefficient | TD | | 7.7 | 14.3 | 9.3 | 15.9 | 5.6 | 7.5 |
| | | | MD | | 5.0 | 3.1 | 2.7 | 4.2 | 1.9 | 2.5 |
| | | | ND | | 23.5 | 19.7 | 14.3 | 23.9 | 10.2 | 13.9 |
| | | (4) Retention rate of | Wet/Dry tension at 23° C. | % | 75.0 | 68.0 | 83.0 | 82.0 | 84.0 | 81.0 |
| | | property upon water | | | | | | | | |
| | | absorption | | | | | | | | |
| | | (5) Charpy Impact strength | | KJ/m2 | 3.4 | 9.0 | 6.7 | 5.2 | 10.2 | 5.8 |
| | | (6) Sliding characteristic | Coefficient of friction | — | 0.10 | 0.16 | 0.11 | 0.20 | >0.5 | 0.20 |
| | | | Wear depth | μm | 2.2 | 4.8 | 5.8 | >1000 | >2000 | >2000 |

| | | | | | | |
|---|---|---|---|---|---|---|
| (1) Surface appearance evaluation | A | B | C | A | A | B |
| of molded article | | | | | | |

The results in Table 1 indicate that the polyamide resin compositions of the present disclosure ertr excellent in compressive resistance characteristics, thermal expansion rate, wear resistance characteristics, physical property retention rate upon water absorption, toughness, and the surface appearance of molded articles. By appropriately adjusting the content ratio of the (B) crystalline semi-aromatic polyamide and the content ratio of the (C) modified elastomer relative to the total amount of polyamides ((A)+(B)) in the compositions of the present embodiment, polyamide resin compositions particularly excellent in the above properties can be obtained.

On the other hand, in the resin compositions in which either one of the components (A), (B), or (C) was not included, the above properties were impaired. Interestingly, in the resin composition in which the (B) crystalline semi-aromatic polyamide was not included, not only the compressive resistance characteristics but also the physical property retention rate upon water absorption were impaired. On the other hand, when the proportion of the (B) component relative to the total mass of the (A) and (B) components was excessively large, the thermal expansion rate was insufficient. As can be understood from these results, it is essential that all of the components (A) to (D) be present and it is indispensable to adjust the contents, in order to exhibit the effects of the present disclosure.

Additionally, the result of Comparative Example 7 indicates that it is necessary in the polyamide resin composition of the present embodiment that the polyolefin-based resin be modified.

### INDUSTRIAL APPLICABILITY

A molded article using the polyamide resin composition of the present embodiment is excellent in heat resistance, compressive resistance characteristics, toughness, thermal expansion rate, and wear resistance, and is also excellent in physical property retention rate upon water absorption, and thus can be suitably used in applications such as automobiles, electrical and electronic materials, industrial equipment, office equipment, and daily goods and household items.

1. A polyamide resin composition comprising:
(A) at least one crystalline aliphatic polyamide;
(B) at least one crystalline semi-aromatic polyamide obtained through a condensation of a diamine having a linear hydrocarbon chain (including a backbone having a side chain) and a dicarboxylic acid having at least one aromatic ring in the molecule thereof;
(C) at least one modified elastomer having a reactive functional group capable of reacting with an end group and/or main chain amide bond of a polyamide resin and having a glass transition temperature of 23° C. or lower; and
(D) a fibrous reinforcing filler,
wherein a mass ratio of a content of the (B) crystalline semi-aromatic polyamide to a total content of the (A) crystalline polyamide and the (B) crystalline semi-aromatic polyamide is 0.10 or more and 0.50 or less.

2. The polyamide resin composition according to claim 1, wherein a content of the (A) crystalline aliphatic polyamide is 50 mass % or more and 90 mass % or less relative to a total mass of the polyamide resin composition.

3. The polyamide resin composition according to claim 1, wherein a ratio (C/N) of a number C of carbon atoms to a number N of nitrogen atoms in a repeating unit of the (A) crystalline aliphatic polyamide is 5.0 or more and 8.0 or less.

4. The polyamide resin composition according to claim 1, wherein the content of the (B) crystalline semi-aromatic polyamide is 5 mass % or more and 50 mass % or less relative to the total mass of the polyamide resin composition.

5. The polyamide resin composition according to claim 1, wherein a ratio (C/N) of a number C of carbon atoms to a number N of nitrogen atoms in a repeating unit of the (B) crystalline semi-aromatic polyamide is 5.0 or more and 8.0 or less.

6. The polyamide resin composition according to claim 1, wherein terephthalic acid accounts for 80 mol % or more of dicarboxylic acids constituting the (B) crystalline semi-aromatic polyamide.

7. The polyamide resin composition according to claim 1, wherein the (B) crystalline semi-aromatic polyamide is polyamide 4T or a copolyamide containing polyamide 4T.

8. The polyamide resin composition according to claim 1, wherein a total content of the (A) crystalline aliphatic polyamide and the (B) crystalline semi-aromatic polyamide is 80 mass % or more relative to all polyamides in the polyamide resin composition.

9. The polyamide resin composition according to claim 1, wherein the polyamide resin composition has two or more melting points, and a difference between the lowest melting point peak temperature (Tm-1) and the highest melting point peak temperature (Tm-2) is 40° C. or higher and 100° C. or lower.

10. The polyamide resin composition according to claim 1, wherein a mass ratio of a content of the (C) modified elastomer to the total content of the (A) crystalline polyamide and the (B) crystalline semi-aromatic polyamide is 0.10 or more and 0.50 or less.

11. The polyamide resin composition according to claim 1, wherein the content of the (C) modified elastomer is 0.1 mass % or more and 15 mass % or less relative to the total mass of the polyamide resin composition.

12. The polyamide resin composition according to claim 1, wherein the (C) modified elastomer is a modified polyolefin-based resin having a reactive functional group capable of reacting with an end group and/or main chain amide bond of a polyamide resin and having a glass transition temperature of 23° C. or lower.

13. The polyamide resin composition according to claim 1, wherein a content of the (D) fibrous reinforcing filler is 10 mass % or more and 50 mass % or less relative to the total mass of the polyamide resin composition.

14. The polyamide resin composition according to claim 1, wherein a linear expansion coefficient in a range of −40° C. to 150° C. is 15×10⁻⁵/K or more.
